(19) United States
(12) Patent Application Publication
(10) Pub. No.: US 2020/0010637 A1
(43) Pub. Date: Jan. 9, 2020

(54) RIGID MONOLAYER CONTAINER

(71) Applicant: THE CHEMOURS COMPANY FC, LLC, WILMINGTON, DE (US)

(72) Inventors: CHERYL MARIE STANCIK, KENNETT SQUARE, PA (US); PHILIPP MARTIN NIEDENZU, WILMINGTON, DE (US); DENISE CONNER, NEWARK, DE (US)

(21) Appl. No.: 16/468,331

(22) PCT Filed: Dec. 13, 2017
(86) PCT No.: PCT/US2017/066105

§ 371 Date: Jun. 11, 2019

Related U.S. Application Data
(60) Provisional application No. 62/433,636, filed on Dec. 13, 2016.

(51) Int. Cl. C08K 3/22; B65D 81/30; B65D 65/38; C08K 9/02; C08K 9/06; C08J 3/22; C08J 5/18

(52) U.S. Cl. CPC C08K 3/22; B65D 81/30; B65D 65/38; C08K 9/02; C08J 2323/06; C08J 3/226; C08J 5/18; C08K 2003/2241; C08K 9/06

(57) ABSTRACT

A new light protective rigid monolayer package which includes TiO₂ particles, at least one color pigment selected from black and yellow, and a polymer. The light protective rigid monolayer package can have an LPF value of at least about 20.

### BACKGROUND OF THE INVENTION

Certain compounds and nutrients contained within packages can be negatively impacted by exposure to light. Many different chemical and physical changes may be made to molecular species as a result of either a direct, or indirect, exposure to light, which can collectively be defined as photochemical processes. As described in Atkins, photochemical processes can include primary absorption, physical processes (e.g., fluorescence, collision-induced emission, stimulated emission, intersystem crossing, phosphorescence, internal conversion, singlet electronic energy transfer, energy pooling, triplet electronic energy transfer, triplet-triplet absorption), ionization (e.g., Penning ionization, dissociative ionization, collisional ionization, associative ionization), or chemical processes (e.g., disassociation or degradation, addition or insertion, abstraction or fragmentation, isomerization, dissociative excitation) (Atkins, P. W.; Table 26.1 Photochemical Processes. Physical Chemistry, 5th Edition; Freeman: New York, 1994; 908.). As one example, light can cause excitation of photosensitizer species (e.g., riboflavin in dairy food products) that can then subsequently react with other species present (e.g., oxygen, lipids) to induce changes, including degradation of valuable products (e.g., nutrients in food products) and evolution of species that can adjust the quality of the product (e.g., off-odors in food products).

As such, there is a need to provide packaging with sufficient light protection properties to allow the protection of the package content(s) and sufficient mechanical properties to withstand shipping, storage, and use conditions.

The ability of packages to protect substances they contain is highly dependent on the materials used to design and construct the package (reference: Food Packaging and Preservation; edited M. Mathlouthi, ISBN: 0-8342-1349-4; Aspen publication; Copyright 1994; Plastic Packaging Materials for Food; Barrier Function, Mass Transport, Quality Assurance and Legislation: ISBN 3-527-28868-6; edited by O. G Piringer; A. L. Baner; Wiley-vch Verlag GmBH, 2000, incorporated herein by reference). Preferred packaging materials are designed with consideration for the penetration of moisture, light, and oxygen often referred to as barrier characteristics.

Light barrier characteristics of materials used for packaging are desired to provide light protection to package contents. Methods have been described to measure light protection of a packaging material and characterize this protection with a “Light Protection Factor” (LPF value) as described in published patent application US20150093832-A1.

Titanium dioxide (TiO₂) is frequently used in plastics food packaging layer(s) at low levels (typical levels of 0.1 wt % to 5 wt % of a composition) to provide aesthetic qualities to a food package such as whiteness and/or opacity. In addition to these qualities, titanium dioxide is recognized as a material that may provide light protection of certain entities as described in, for example, U.S. Pat. Nos. 5,750,226; 6,465,062; and US20040195141; however, the use of TiO₂ as a light protection material in plastic packages has been limited due to challenges to process titanium dioxide compositions at high loading levels or levels high enough to provide the desired light protection.

Useful packaging designs are those that provide the required light protection and functional performance at a reasonable cost for the target application. The cost of a packaging design is in part determined by the materials of construction and the processing required to create the packaging design.

Dairy milk packaging is an application where there is a benefit for light protection in packages to protect dairy milk from the negative impacts of light exposure. Light exposure to dairy milk may result in the degradation of some chemical species in the milk; this degradation results in a decrease in the nutrient levels and sensory quality of the milk (e.g., “Riboflavin Photosensitized Singlet Oxygen Oxidation of Vitamin D”, J. M. King and D. B. Min, V 63, No. 1, 1998, Journal of Food Science, page 31). Hence protection of dairy milk from light with light protection packaging will allow the nutrient levels and sensory quality to be preserved at their initial levels for extended periods of time as compared to milk packaged in typical packaging that does not have light protection (e.g., “Effect of Package Light Transmittance on Vitamin Content of Milk. Part 2: UHT Whole Milk.” A. Saffert, G. Pieper, J. Jetten; Packaging Technology and Science, 2008; 21: 47-55).

Additionally, multilayered structures are seen as a means to achieve light protection qualities in package designs. Typically, more than one layer of material is required for adequate protection of food from light and mechanical damage. For example, Cook et al. (U.S. Pat. No. 6,465,062) present a multilayer packaging container design to achieve light barrier characteristics with other functional barrier layers. Problems associate with multilayered packaging structures are they require more complex processing, additional materials for each layer, higher package cost, and risk delamination of layers. Deficiencies of multilayer designs and benefits of monolayer designs are discussed in US 20040195141 in section [0022] and [0026]. Thus, there is a commercial need to create a monolayer food package that achieves, or exceeds, the light protection and mechanical strength properties of a multilayer package.

Flexible packages can be useful for certain applications prepared with the materials as used for the rigid packages discussed in this application. Such flexible packages may be of different thickness and may require additional components for mechanical or functional purposes.

### SUMMARY OF THE INVENTION

Surprisingly a new light protective monolayer package has been developed utilizing TiO₂ particles at moderate concentration levels not exceeding about 8 wt % of the total weight of a packaging composition with small loadings of colored pigment materials, typically less than 0.03 wt %, offering a synergistic performance when incorporated together. The monolayer package of the present invention has superior light protection properties while maintaining sufficient mechanical properties. The TiO₂ particles combined with colored pigments can be dispersed and processed in package production processes by use of incorporation with a masterbatch, and preferably processed into a package, for example using blow molding methods for package production. Extrusion and stretch blow molding are useful methods for package production. The colored pigments are most preferably yellow or black and can be used in combination or separately. Other pigments and additives may be used for additional performance or aesthetic needs.

The invention comprises a rigid, monolayer light protective package. The monolayer package comprises TiO₂ particles, at least one color pigment, the at least one color pigment preferably is selected from the group consisting of black and yellow, and a polymer, wherein the TiO₂ particles and at least one color pigment are dispersed throughout the polymer. The monolayer package has superior light protection properties while maintaining necessary mechanical properties. The monolayer package can have a light protection factor (“LPF value”) value of 20 or greater, preferably greater than 30, more preferably greater than 40 or even more preferably greater than 50.

### DETAILED DESCRIPTION OF THE DISCLOSURE

In this disclosure “comprising” is to be interpreted as specifying the presence of the stated features, integers, steps, or components as referred to, but does not preclude the presence or addition of one or more features, integers, steps, or components, or groups thereof. Additionally, the term “comprising” is intended to include examples encompassed by the terms “consisting essentially of” and “consisting of.” Similarly, the term “consisting essentially of” is intended to include examples encompassed by the term “consisting of.”

In this disclosure, when an amount, concentration, or other value or parameter is given as either a range, typical range, or a list of upper typical values and lower typical values, this is to be understood as specifically disclosing all ranges formed from any pair of any upper range limit or typical value and any lower range limit or typical value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

In this disclosure, terms in the singular and the singular forms “a,” “an,” and “the,” for example, includes plural references unless the content clearly dictates otherwise. Thus, for example, reference to “TiO₂ particle”, “a TiO₂ particle”, or “the TiO₂ particle” also includes a plurality of TiO₂ particles. All references cited in this patent application are herein incorporated by reference.

The invention comprises a rigid, monolayer light protective package. The monolayer comprises TiO₂ particles, at least one color pigment preferably selected from the group consisting of black and yellow, and a polymer, wherein the TiO2 particles and at least one color pigment are dispersed throughout the polymer. The monolayer protects food within the package from light and contains the food. The monolayer has superior light protection properties while maintaining necessary mechanical properties. The monolayer can have an LPF value of 20 or greater, preferably greater than 30, more preferably greater than 40 or even more preferably greater than 50. The titanium dioxide and at least one color pigment can be dispersed and processed in package production processes by incorporating a masterbatch, and preferably processed into a package using blow molding methods. The masterbatch can be solid pellets. The TiO2 and color pigment could also be delivered in other forms, such as a liquid and do not have to be delivered in one single masterbatch formulation.

One embodiment of the present invention comprises a package for one or more light sensitive products comprising: a) a monolayer comprising TiO₂ particles, at least one color pigment selected from the group consisting of black and yellow, and one or more melt processable resin(s), wherein the monolayer has an LPF value of at least about 20, and the concentration of TiO₂ particles is at least one (1) wt. % of the monolayer; and b) optionally one or more aesthetic layers.

In another embodiment, the rigid monolayer comprises PET, about 6.3 wt % TiO₂ and 0.002 wt % FDA black pigment, and has a thickness of about 28 mil.

In an aspect of the invention the TiO₂ particles can be first coated with a metal oxide and then coated with an organic material.

It is preferred that the metal oxide is selected from the group consisting of silica, alumina, zirconia, or combinations thereof. It is most preferred that the metal oxide is alumina. It is preferred that the organic coating material on the TiO₂ is selected from the group consisting of an organo-silane, an organo-siloxane, a fluoro-silane, an organo-phosphonate, an organo-acid phosphate, an organo-pyrophosphate, an organo-polyphosphate, an organo-metaphosphate, an organo-phosphinate, an organo-sulfonic compound, a hydrocarbon-based carboxylic acid, an associated ester of a hydrocarbon-based carboxylic acid, a derivative of a hydrocarbon-based carboxylic acid, a hydrocarbon-based amide, a low molecular weight hydrocarbon wax, a low molecular weight polyolefin, a co-polymer of a low molecular weight polyolefin, a hydrocarbon-based polyol, a derivative of a hydrocarbon-based polyol, an alkanolamine, a derivative of an alkanolamine, an organic dispersing agent, or a mixture thereof. It is more preferred that the organic material is an organo-silane having the formula: R⁵ₓSiR⁶₄₋ₓ wherein R⁵ is a nonhydrolyzable alkyl, cycloalkyl, aryl, or aralkyl group having at least 1 to about 20 carbon atoms; R⁶ is a hydrolyzable alkoxy, halogen, acetoxy, or hydroxy group; and x=1 to 3. It is most preferred that the organic material is Octyltriethoxysilane. In an aspect of the invention the monolayer can have a concentration of TiO₂ particles of from above 0 wt % to about 8 wt % of the monolayer, preferably 0.5 to 8 wt. % of the monolayer, more preferably 0.5 to 4 wt. % of the monolayer. The melt processable resin(s) can be selected from the group of polyolefins. In an aspect of the invention the melt processable resin is preferably a high-density polyethylene and the monolayer has a thickness of 10 mil to 35 mil. In a further aspect of the invention the metal oxide is alumina and the organic material is octyltriethoxysilane.

In an aspect of the invention the TiO₂ particles can be coated with a metal oxide, preferable alumina, and then an additional organic layer. The treated TiO₂ is an inorganic particulate material that can be uniformly dispersed throughout a polymer melt, and imparts color and opacity to the polymer melt. Reference herein to TiO₂ without specifying additional treatments or surface layers does not imply that it cannot have such layers.

TiO₂ particles may be in the rutile or anatase crystalline form. It is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of precipitation steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference.

Preferred TiO₂ particles comprise particles having a median diameter range of 100 nm to 250 nm as measured by X-Ray centrifuge technique, specifically utilizing a Brookhaven Industries model TF-3005W X-ray Centrifuge Particle Size Analyzer. The crystal phase of the TiO₂ is preferably rutile. The TiO₂ after receiving surface treatments will have a mean size distribution in diameter of about 100 nm to 400 nm, more preferably 100 nm to 250 nm. Nanoparticles (those have mean size distribution less than about 100 nm in their diameter) could also be used in this invention but may provide different light protection performance properties.

The TiO₂ particles may be substantially pure, such as containing only titanium dioxide, or may be treated with other metal oxides, such as silica, alumina, and/or zirconia. TiO₂ particles coated/treated with alumina are preferred in the packages of the present invention. The TiO₂ particles may be treated with metal oxides, for example, by co-oxidizing or co-precipitating inorganic compounds with metal compounds. If a TiO₂ particle is co-oxidized or co-precipitated, then up to about 20 wt. % of the other metal oxide, more typically, 0.5 to 5 wt. %, most typically about 0.5 to about 1.5 wt. % may be present, based on the total particle weight.

The treated titanium dioxide can be formed, for example, by the process comprising: (a) providing titanium dioxide particles having on the surface of said particles a substantially encapsulating layer comprising a pyrogenically-deposited metal oxide or precipitated inorganic oxides; (b) treating the particles with at least one organic surface treatment material selected from an organo-silane, an organo-siloxane, a fluoro-silane, an organo-phosphonate, an organo-acid phosphate, an organo-pyrophosphate, an organo-polyphosphate, an organo-metaphosphate, an organo-phosphinate, an organo-sulfonic compound, a hydrocarbon-based carboxylic acid, an associated ester of a hydrocarbon-based carboxylic acid, a derivative of a hydrocarbon-based carboxylic acid, a hydrocarbon-based amide, a low molecular weight hydrocarbon wax, a low molecular weight polyolefin, a co-polymer of a low molecular weight polyolefin, a hydrocarbon-based polyol, a derivative of a hydrocarbon-based polyol, an alkanolamine, a derivative of an alkanolamine, an organic dispersing agent, or a mixture thereof; and (c) optionally, repeating step (b).

An example of a method of treating or coating TiO₂ particles with amorphous alumina is taught in Example 1 of U.S. Pat. No. 4,460,655 incorporated herein by reference. In this process, fluoride ion, typically present at levels that range from about 0.05 wt. % to 2 wt. % (total particle basis), is used to disrupt the crystallinity of the alumina, typically present at levels that range from about 1 wt. % to about 8 wt. % (total particle basis), as the latter is being deposited onto the titanium dioxide particles. Note that other ions that possess an affinity for alumina such as, for example, citrate, phosphate or sulfate can be substituted in comparable amounts, either individually or in combination, for the fluoride ion in this process. The performance properties of white pigments comprising TiO₂ particles coated with alumina or alumina-silica having fluoride compound or fluoride ions associated with them are enhanced when the coated TiO₂ is treated with an organosilicon compound. The resulting compositions are particularly useful in plastics applications. Further methods of treating or coating particles of the present invention are disclosed, for example, in U.S. Pat. No. 5,562,990 and US 2005/0239921, the subject matter of which is herein incorporated by reference.

Titanium dioxide particles may be treated with an organic compound such as low molecular weight polyols, organosiloxanes, organosilanes, alkylcarboxylic acids, alkylsulfonates, organophosphates, organophosphonates and mixtures thereof. The preferred organic compound is selected from the group consisting of low molecular weight polyols, organosiloxanes, organosilanes and organophosphonates and mixtures thereof and the organic compound is present at a loading of between 0.2 wt % and 2 wt %, 0.3 wt % and 1 wt %, or 0.7 wt % and 1.3 wt % on a total particle basis. The organic compound can be in the range of about 0.1 to about 25 wt %, or 0.1 to about 10 wt %, or about 0.3 to about 5 wt %, or about 0.7 to about 2 wt %. One of the preferred organic compounds used in the present invention is polydimethyl siloxane; other preferred organic compounds used in the present invention include carboxylic acid containing material, a polyalcohol, an amide, an amine, a silicon compound, another metal oxide, or combinations of two or more thereof.

In a preferred embodiment, the at least one organic surface treatment material is an organo-silane having the formula: R⁵ₓSiR⁶₄₋ₓ wherein R⁵ is a nonhydrolyzable alkyl, cycloalkyl, aryl, or aralkyl group having at least 1 to about 20 carbon atoms; R⁶ is a hydrolyzable alkoxy, halogen, acetoxy, or hydroxy group; and x=1 to 3. Octyltriethoxysilane is a preferred organo-silane.

The following TiO₂ pigments may be useful in the present invention: Chemours Ti-Pure™ R-101, 104, 105, 108, 350, 1600, and 1601. Other TiO₂ grades with similar size and surface treatments may also be useful in the invention.

The following pigments may be used in accordance with the present invention as further described below.

The CIELAB 1976 color scale is useful for defining the color of pigments and plastics. This color scale numerically describes the colors on perceptual axes of L* (monochromatic brightness), b* (yellow in positive direction and blue in negative direction) and b* (red in positive direction and green in negative direction).

Yellow Colored Pigments

The monolithic rigid article may comprise a colorant which shifts the color space to lower L* and/or higher b* values. Yellow colorants will shift the color space to higher b* values. Yellow colorants classified as pigments or dyes are typically selected from the group consisting of monoazo derivatives, bisazo derivatives, quinoline derivatives, xanthene derivatives and combinations thereof. Yellow pigments, dyes or combination of said materials are suitable for use according to the method of the present invention include any of the following pigment or dyes with the following PY designations:

| CIGN | CICN | CAS No. | Pigment Class |
|---|---|---|---|
| P.Y.1 | 11680 | 2512-29-0 | Monoazo Yellow |
| P.Y.2 | 11730 | 6486-26-6 | Monoazo Yellow |
| P.Y.3 | 11710 | 6486-23-3 | Monoazo Yellow |
| P.Y.5 | 11660 | 4106-67-6 | Monoazo Yellow |
| P.Y.6 | 11670 | 4106-76-7 | Monoazo Yellow |
| P.Y.10 | 12710 | 6407-75-6 | Monoazo Yellow |
| P.Y.12 | 21090 | 6358-85-6 | Diarylide Yellow |
| P.Y.13 | 21100 | 5102-83-0 | Diarylide Yellow |
| P.Y.14 | 21095 | 5468-75-7 | Diarylide Yellow |
| P.Y.16 | 20040 | 5979-28-2 | Bisacetoacetarylide |
| P.Y.17 | 21105 | 4531-49-1 | Diarylide Yellow |
| P.Y.24 | 70600 | 475-71-8 | Flavanthrone |
| P.Y.49 | 11765 | 2904-04-3 | Monoazo Yellow |
| P.Y.55 | 21096 | 6358-37-8 | Diarylide Yellow |
| P.Y.60 | 12705 | 6407-74-5 | Monoazo Yellow |
| P.Y.61 | 13880 | 12286-65-6 | Monoazo Yellow, |
| P.Y.62 | 13940 | 12286-66-7 | Monoazo Yellow, |
| P.Y.63 | 21091 | 14569-54-1 | Diarylide Yellow |
| P.Y.65 | 11740 | 6528-34-3 | Monoazo Yellow |
| P.Y.73 | 11738 | 13515-40-7 | Monoazo Yellow |
| P.Y.74 | 11741 | 6358-31-2 | Monoazo Yellow |
| P.Y.75 | 11770 | 52320-66-8 | Monoazo Yellow |
| P.Y.81 | 21127 | 22094-93-5 | Diarylide Yellow |
| P.Y.83 | 21108 | 5567-15-7 | Diarylide Yellow |
| P.Y.87 | 21107:1 | 15110-84-6 | Diarylide Yellow |
| P.Y.90 | — | — | Diarylide Yellow |
| P.Y.93 | 20710 | 5580-57-4 | Disazo Condensation |
| P.Y.94 | 20038 | 5580-58-5 | Disazo Condensation |
| P.Y.95 | 20034 | 5280-80-8 | Disazo Condensation |
| P.Y.97 | 11767 | 12225-18-2 | Monoazo Yellow |
| P.Y.98 | 11727 | 12225-19-3 | Monoazo Yellow |
| P.Y.99 | — | 12225-20-6 | Anthraquinone |
| P.Y.100 | 19140:1 | 12225-21-7 | Monoazopyrazolone |
| P.Y.101 | 48052 | 2387-03-3 | Aldazine |
| P.Y.104 | 15985:1 | 15790-07-5 | Naphth. sulfonic acid |
| P.Y.106 | — | 12225-23-9 | Diarylide Yellow |
| P.Y.108 | 68420 | 4216-01-7 | Anthrapyrimidine |
| P.Y.109 | 56284 | 12769-01-6 | Isoindolinone |
| P.Y.110 | 56280 | 5590-18-1 | Isoindolinone |
| P.Y.111 | 11745 | 15993-42-7 | Monoazo Yellow |
| P.Y.113 | 21126 | 14359-20-7 | Diarylide Yellow |
| P.Y.114 | 21092 | 71872-66-7 | Diarylide Yellow |
| P.Y.116 | 11790 | 30191-02-7 | Monoazo Yellow |
| P.Y.117 | 48043 | 21405-81-2 | Metal Complex |
| P.Y.120 | 11783 | 29920-31-8 | Benzimidazolone |
| P.Y.121 | 21091 | 61968-85-2 | Diarylide Yellow |
| P.Y.123 | 65049 | 4028-94-8 | Anthraquinone |
| P.Y.124 | 21107 | 67828-22-2 | Diarylide Yellow |
| P.Y.126 | 21101 | 90268-23-8 | Diarylide Yellow |
| P.Y.127 | 21102 | 71872-67-8 | Diarylide Yellow |
| P.Y.128 | 20037 | 57971-97-8 | Disazo Condensation |
| P.Y.129 | 48042 | 68859-61-0 | Metal Complex |
| P.Y.130 | 117699 | 23739-66-4 | Monoazo Yellow |
| P.Y.133 | 139395 | 85702-92-2 | Monoazo Yellow |
| P.Y.136 | — | — | Diarylide Yellow |
| P.Y.138 | 56300 | 56731-19-2 | Quinophthalone |
| P.Y.139 | 56298 | 36888-99-0 | Isoindoline |
| P.Y.142 | — | 67355-35-5 | Monoazo Yellow |
| P.Y.147 | 60645 | 76168-75-7 | Anthraquinone |
| P.Y.148 | 59020 | 20572-37-6 | |
| P.Y.150 | 12764 | 68511-62-6 | Metal Complex |
| P.Y.151 | 13980 | 61036-28-0 | Benzimidazolone |
| P.Y.152 | 21111 | 20139-66-6 | Diarylide Yellow |
| P.Y.153 | 48545 | 68859-51-8 | Metal Complex |
| P.Y.154 | 11781 | 68134-22-5 | Benzimidazolone |
| P.Y.155 | 200310 | 68516-73-4 | Bisacetoacetarylide |
| P.Y.165 | — | — | Monoazo Yellow |
| P.Y.166 | 20035 | 76233-82-4 | Disazo Condensation |
| P.Y.167 | 11737 | 38489-24-6 | Monoazo Yellow |
| P.Y.168 | 13960 | 71832-85-4 | Monoazo Yellow |
| P.Y.169 | 13955 | 73385-03-2 | Monoazo Yellow |
| P.Y.170 | 21104 | 31775-16-3 | Diarylide Yellow |
| P.Y.171 | 21106 | 53815-04-6 | Diarylide Yellow |
| P.Y.172 | 21109 | 762353-0 | Diarylide Yellow |
| P.Y.173 | 561600 | 96352-23-7 | Isoindolinone |
| P.Y.174 | 21098 | 78952-72-4 | Diarylide Yellow |
| P.Y.175 | 11784 | 35636-63-6 | Benzimidazolone |
| P.Y.176 | 21103 | 90268-24-9 | Diarylide Yellow |
| P.Y.177 | 48120 | 60109-88-8 | Metal Complex |
| P.Y.179 | 48125 | 63287-28-5 | Metal Complex |
| P.Y.180 | 21290 | 77804-81-0 | Benzimidazolone |
| P.Y.181 | 11777 | 74441-05-7 | Benzimidazolone |
| P.Y.182 | 128300 | 67906-31-4 | Polycycl. Pigment |
| P.Y.183 | 18792 | 65212-77-3 | Monoazo Yellow |
| P.Y.185 | 56280 | 76199-85-4 | Isoindoline |
| P.Y.187 | — | 131439-24-2 | Polycycl. Pigment |
| P.Y.188 | 21094 | 23792-68-9 | Diarylide Yellow |
| P.Y.190 | 189785 | 141489-68-1 | Monoazo Yellow |
| P.Y.191 | 18795 | 129423-54-7 | Monoazo pyrazolone |
| P.Y.191:1 | 18795 | 154946-66-4 | Monoazo pyrazolone |
| P.Y.192 | 507300 | — | Heterocyclus |
| P.Y.193 | 65412 | 70321-14-1 | Anthraquinone |
| P.Y.194 | 11785 | 82199-12-0 | Benzimidazolone |
| P.Y.198 | — | 83372-55-8 | Bisacetoacetarylide |
| P.Y.199 | 653200 | 136897-58-0 | Anthraquinone |
| P.Y.201 | — | 60024-34-2 | Monoazo |
| P.Y.202 | 65440 | — | Anthraquinone |
| P.Y.203 | 117390 | — | Monoazo |
| P.Y.205 | — | — | Azo metal salt |
| P.Y.206 | — | — | Azo metal salt |
| P.Y.209 | — | — | Azo metal salt |
| P.Y.209:1 | — | — | Monoazo metal salt |
| P.Y.212 | — | — | Azo metal salt |
| P.Y.213 | 11875 | 220198-21-0 | Monoazo/Chinazolondion |
| P.Y.214 | — | — | Disazo/Benzimidazolone |

CIGN = Color Index ™ Generic Name
CICN = Color Index ™ Color Number

Such yellow pigments are available commercially or may be made by means well known in the art.

Yellow dyes suitable for use according to the method of the present invention include color index disperse yellow 54, color index disperse yellow 201, color index pigment yellow 138, color index 11020 methyl yellow, color index 11855 disperse yellow 3, color index 13065 metanil yellow, color index 13900 acid yellow 99 and other acid yellow dyes, color index 13920 direct yellow 8 and other direct yellow dyes, color index 14025 alizarin yellow, GG color index 14045 mordant yellow 12, color index 15985 sunset yellow FCF, color index 24890 brilliant yellow, color index 46025 acridine yellow G, 3-carboxy-5-hydroxy-I-p-sulfophenyl-4-p-sulfophenylazopyrazole trisodium salt (yellow dye #5), and 1-(sulphophenylazo)2-napthol-6-sulphonic acid disodium salt (yellow dye #6). Such yellow dyes are available commercially or may be made by means well known in the art.

Natural yellow will shift the color space to higher b* values. Yellow colorants are typically selected from the group consisting of inorganic oxides or sulfides, and combinations thereof. Natural yellow pigments suitable for use according to the method of the present invention include any of the following: As2S3, CdS (PY37), PbCrO4 (PY34), K3Co(NO2)6, (PY40): Fe2O3.H2O (PY43), Pb(SbO3)2/Pb3(SbO4)2 (PY41), PbSnO4 or Pb(Sn,Si)O3, NiO.Sb2O3.2OTiO₂ (PY53), and SnS2. Such natural yellow pigments are available commercially or may be made by means well known in the art.

Black Colored Pigments

Black pigments decrease L* measurement with minimal alteration of a* and b* values. Black pigments, dyes or combinations of said materials are suitable for use according to the method of the present invention and include naturally and synthetically derived black pigments such as carbon black (furnace or channel process), inorganic oxides, inorganic sulfides, minerals, and organic black dyes and pigments. Such pigments and dyes are available commercially or may be made by means well known in the art, and may include any the following:

| CIGN | CICN | CAS No. | Pigment Class |
|---|---|---|---|
| PBk1 | 50440 | 13007-86-8 | Aniline Black |
| PBk6 | 77266 | 1333-86-4 | Carbon Black & Shungite |
| PBk7 | 77266 | 1333-86-4 | Carbon Black (Lamp Black) |
| PBk8 | 77268 | 1339-82-8 | Carbon Black (Vine Black) |
| PBk9 | 77267 | 8021-99-6 | Carbon Black (Bone Black) |
| PBk10 | 77265 | 7782-42-5 | Graphite |
| PBk11 | 77498, | 1309-38-2, | Metal oxide |
| | 77499 | 12227-89-3 | |
| PBk12 | 77543 | 68187-02-0 | Mixed metal oxide |
| PBk13 | 77322 | 1037-96-6 | Metal oxide |
| PBk14 | 77728 | 1313-13-9 | Metal oxide |
| PG17Blk | 77543 | 68187-02-0 | Mixed metal oxide |
| PBk17 | 77975 | — | Metal sulfide |
| PBk18 | 77011 | 12001-98-8 | Mineral |
| PBk19 | 77017 | — | Mineral |
| PBk20 | — | 12216-93-2 | Anthraquinone |
| PBk22 | 77429 | 55353-02-1 | Mixed metal oxide |
| PBk23 | 77865 | 68187-54-2 | Mixed metal oxide |
| PBk24 | 77898 | 68187-00-8 | Mixed metal oxide |
| PBk25 | 77332 | 68186-89-0 | Mixed metal oxide |
| PBk26 | 77494 | 68186-94-7 | Mixed metal oxide |
| PBk27 | 77502 | 68186-97-0 | Mixed metal oxide |
| PBk28 | 77428 | 68186-91-4 | Mixed metal oxide |
| PBk29 | 77498 | 68187-50-8 | Mixed metal oxide |
| PBk30 | 77504 | 71631-15-7 | Mixed metal oxide |
| PBk31 | 71132 | 67075-37-0 | Metal-organic perylene |
| PBk32 | 71133 | 83524-75-8 | Metal-organic perylene |
| PBk33 | 77537 | 75864-23-2 | Mixed metal oxide |
| PBk34 | 77770 | 56780-54-2 | Metal sulfide |
| PBk35 | 77890 | 51745-87-0 | Metal oxide |

CIGN = Color Index ™ Generic Name
CICN = Color Index ™ Color Number

When the TiO₂ particles and color pigments are used in a polymer composition/melt, the melt-processable polymer that can be employed together with the TiO₂ particles and color pigments comprise a high molecular weight polymer, preferably thermoplastic resin. By “high molecular weight” it is meant to describe polymers having a melt index value of 0.01 to 50, typically from 2 to 10 as measured by ASTM method D1238-98. By “melt-processable,” it is meant a polymer must be melted (or be in a molten state) before it can be extruded or otherwise converted into shaped articles, including films and objects having from one to three dimensions. Also, it is meant that a polymer can be repeatedly manipulated in a processing step that involves obtaining the polymer in the molten state. Polymers that are suitable for use in this invention include, by way of example but not limited thereto, polymers of ethylenically unsaturated monomers including olefins such as polyethylene, polypropylene, polybutylene, and copolymers of ethylene with higher olefins such as alpha olefins containing 4 to 10 carbon atoms or vinyl acetate; vinyls such as polyvinyl chloride, polyvinyl esters such as polyvinyl acetate, polystyrene, acrylic homopolymers and copolymers; phenolics; alkyds; amino resins; polyamides; phenoxy resins, polysulfones; polycarbonates; polyesters and chlorinated polyesters; polyethers; acetal resins; polyimides; and polyoxyethylenes. Mixtures of polymers are also contemplated. Polymers suitable for use in the present invention also include various rubbers and/or elastomers, either natural or synthetic polymers based on copolymerization, grafting, or physical blending of various diene monomers with the above-mentioned polymers, all as generally known in the art. Typically, the polymer may be selected from the group consisting of polyolefin, polyvinyl chloride, polyamide and polyester, and mixture of these. More typically used polymers are polyolefins. Most typically used polymers are polyolefins selected from the group consisting of polyethylene, polypropylene, and mixture thereof. A typical polyethylene polymer is low density polyethylene, linear low density polyethylene, and high density polyethylene (HDPE).

A wide variety of additives may be present in the packaging composition of this invention as necessary, desirable, or conventional. Such additives include polymer processing aids such as fluoropolymers, fluoroelastomers, etc., catalysts, initiators, antioxidants (e.g., hindered phenol such as butylated hydroxytoluene), blowing agent, ultraviolet light stabilizers (e.g., hindered amine light stabilizers or “HALS”), organic pigments including tinctorial pigments, plasticizers, antiblocking agents (e.g. clay, talc, calcium carbonate, silica, silicone oil, and the like) leveling agents, flame retardants, anti-cratering additives, and the like. Additional additives further include plasticizers, optical brighteners, adhesion promoters, stabilizers (e.g., hydrolytic stabilizers, radiation stabilizers, thermal stabilizers, and ultraviolet (UV) light stabilizers), antioxidants, ultraviolet ray absorbers, anti-static agents, colorants, dyes or pigments, delustrants, fillers, fire-retardants, lubricants, reinforcing agents (e.g., glass fiber and flakes), processing aids, anti-slip agents, slip agents (e.g., talc, anti-block agents), and other additives.

Any melt compounding techniques known to those skilled in the art may be used to process the compositions of the present invention. Packages of the present invention may be made after the formation of a masterbatch. The term masterbatch is used herein to describe a mixture of TiO₂ particles and color pigments (collectively called solids) which can be melt processed at high solids to resin loadings (generally 50-80 wt % by weight of the total masterbatch) in high shear compounding machinery such as Banbury mixers, continuous mixers or twin screw mixers, which are capable of providing enough shear to fully incorporate and disperse the solids into the melt processable resin. The resultant melt processable resin product is commonly known as a masterbatch, and is typically subsequently diluted or “letdown” by incorporation of additional virgin melt processable resin in plastic production processes. The letdown procedure is accomplished in the desired processing machinery utilized to make the final consumer article, whether it is sheet, film, bottle, package or another shape. The amount of virgin resin utilized and the final solids content is determined by the use specifications of the final consumer article.

In another embodiment of the present invention, the titanium dioxide and color pigment are supplied for processing into the package as a masterbatch concentrate. Preferred masterbatch concentrates typically have titanium dioxide content of greater than 40 wt %, greater than 50 wt %, greater than 60 wt %, or greater than 70 wt %. Preferred color concentrate masterbatches are solid. Liquid color concentrates and/or a combination of liquid and solid color concentrates could be used.

In an aspect of the invention, the monolayer package may be a film, package, or container and may have a monolayer sheet or wall thickness of from about 5 mils to about 100 mils, preferably from about 10 mils to about 40 mils, and preferably still from about 35 mils to about 40 mils. The amount of inorganic solids present in the particle-containing polymer composition and package will vary depending on the end use application.

The amount of titanium dioxide particles in the package of the invention, can be at least about 0.01 wt %, and preferably at least about 0.1 wt %. In an aspect of the invention the titanium dioxide particles in the package can be from about 0.01 wt % to about 20 wt %, and is preferably from about 0.1 wt % to about 15 wt %, more preferably 5 wt % to 10 wt %. In a further aspect of the invention the titanium dioxide particles in the package can be from at least about 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt % to 12 wt % and any amount between 0.1 wt % and 12 wt % (based on the total weight of the monolayer).

A package is typically produced by melt blending the masterbatch containing the titanium dioxide and color pigment with a second high molecular weight melt-processable polymer to produce the desired composition used to form the finished monolayer package. The masterbatch composition and second high molecular weight polymer can be melt blended, using any means known in the art, as disclosed above in desired ratios to produce the desired composition of the final monolayer package. In this process, twin-screw extruders are commonly used. The resultant melt blended polymer is extruded or otherwise processed to form a package, sheet, or other shaped article of the desired composition. The melt blended polymer may be injection molded into a preform for subsequent stretch blow molding processing.

The shaped monolayer package may be provided with one or more additional aesthetic layers. Such layer or layers may be formed from a label, paper, printed ink, wrap, or other material. The layer or layers may cover part or all of the surface of the package. The aesthetic layer or layers may be on the internal or external walls of the package. The aesthetic layer or layers may contribute some light protection performance to the package, but the primary light protection monolayer disclosed above provides substantially more light protection than the light protection provided by the aesthetic layer or layers.

The shaped article, or package, may have one or more additional functional layer or layers. Such layer or layers may be formed from a label, paper, printed ink, wrap, coating treatment or other material. The layer or layers may cover part or all the surface of the package. The functional layer or layers may be on the internal walls of the package. The functional layer or layers may contribute some light protection performance to the package, but the primary light protection monolayer disclosed above provides substantially more light protection than the light protection provided by the functional layer or layers.

Layers applied for aesthetic purposes, including for branding and product information like nutrition and ingredient labels, may in some cases not be complete layers. For example, labels may only cover a small area on the surface area of a package or a wrap may cover the sides of a package, but not the base. Such incomplete layers cannot provide fully effective light protection as light can enter the package through the surfaces of the package that are not covered by the layer. As light can enter the package from any direction, having complete coverage of the package is an important consideration in the package light protection design. Hence, aesthetic layers are often deficient in providing the primary mode of light protection for a package design. Functional layers typically have a narrowly defined purpose, such as providing gas barrier properties or to prevent interactions of layers or to bind two layers together and thus are not designed for light protection. The present invention addresses this challenge by providing and designing light protection directly into the primary package thus imparting light protection to substantially all the package surface.

The monolayer package can also be provided with a removable seal over an opening in the monolayer package. An example of removable seals is a foil. The monolayer package can also be provided with a seal that can be opened and reclosed.

In an aspect of the invention, extrusion blow molding can be used to produce the monolayer package. In yet another embodiment, a preform can be produced by injection molding and subsequently used to produce the package using a stretch blow molding process.

### General Steps of Blow Molding

Blow molding is a molding process in which air pressure is used to inflate soft plastic into a mold cavity. Blow molding techniques have been disclosed in the art, for example in “Petrothene® Polyolefins . . . a processing guide”, 5^{th} Edition, 1986, U.S.I Chemicals. Blow molding is an important industrial process for making hollow plastic parts with thin walls, such as bottles and similar containers. Blow molding is accomplished in two stages: (1) fabrication of a starting tube of molten plastic, called a parison, or an injection molded preform that is properly heated to a molten state; and (2) inflation of the tube or preform in a mold to the desired final shape. Forming the parison or preform is accomplished by either of two processes: extrusion or injection molding.

Extrusion blow molding contains four steps: (1) extrusion of parison; (2) parison is pinched at the top and sealed at the bottom around a metal blow pin as the two halves of the mold come together; (3) the tube is inflated so that it takes the shape of the mold cavity; and (4) mold is opened to remove the solidified part.

Injection blow molding contains the same steps as blow molding; however, is the injection molded preform is used rather than an extruded parison: (1) preform is injection molded; (2) injection mold is opened and preform is transferred to a blow mold; (3) preform is heated to become molten and inflated to conform to a blow mold; and (4) blow mold is opened and blown product is removed.

Blow molding is limited to thermoplastics. Polyethylene is the polymer most commonly used for blow molding; in particular, high density and high molecular weight polyethylene (HDPE and HMWPE). In comparing their properties with those of low density PE given the requirement for stiffness in the final product, it is more economical to use these more expensive materials because the container walls can be made thinner. Other blow moldings are made of polypropylene (PP), polyvinylchloride (PVC), and polyethylene terephthalate (PET).

One embodiment of the present invention is a composition comprising a melt processable resin, titanium dioxide, and at least one color pigment selected from the group consisting of black and yellow. The composition is typically processed by injection or blow molding to form a rigid monolayer package. The processing method can yield a monolayer thickness of any suitable thickness. For example, monolayer thicknesses can range from about 5 mils to about 100 mils, preferably from about 10 mils to about 40 mils, and preferably still from about 35 mils to about 40 mils.

Another embodiment of the present invention is a composition comprising a melt processable resin and treated TiO₂ at TiO₂ weight percentages of greater than 6 wt % in the package. In yet another embodiment, the melt processable resin used is HDPE.

In an embodiment of the present invention, the composition is used to create a blow molded plastic container or package. This package can be of one piece with relatively thin walled construction or have multiple pieces or other package features such as spouts, closures, handles, and labels. The plastic container construction of this invention is characterized by improved light protection characteristics for a given amount of plastic material employed in the fabrication thereof, without interfering with the previously established standards of configuration, e.g., package shape, for adapting the container to particular automated end use applications, such as packaging, filling and the like. This plastic container can be used to contain many products including dairy milk, plant based milk (e.g., almond milk, soy milk, etc.), yogurt drinks, cultured dairy products, teas, juices or other beverage and fluid products. The package is particularly useful for protection of light sensitive entities present in food products.

In another embodiment of the present invention, the package of the invention includes one or more aesthetic layers.

In a further embodiment of the present invention, the package produced can be recycled.

Measuring Light Protection Performance or LPF

The LPF value quantifies the protection a packaging material can provide for a light sensitive entity in a product when the packaged product is exposed to light. The LPF value for a packaging material is quantified in our experiment as the time when half of the product light sensitive entity concentration has been degraded or otherwise undergone transformation in the controlled experimental light exposure conditions. Hence, a product comprising one or more light sensitive entities protected by a high LPF value package can be exposed to a larger dose of light before changes will occur to the light sensitive entity versus the product protected by a low LPF value package.

A detailed description of measuring LPF value is further described in published patent application numbers WO2013/163421 titled, “Methods for Determining Photo Protective Materials” and WO2013/162947 titled, “Devices for Determining Photo Protective Materials incorporated herein by reference. Additional information may be found in the Examples herein. The LPF values reported in the Examples that follow were measured according to the teachings of the above patent applications.

The current invention is focused on identifying new packages with light protective properties that protect species from photo chemical process (e.g., photo oxidation). Photochemical processes alter entities such as riboflavin, curcurim, myoglobin, chlorophyll (all forms), vitamin A, and erythrosine under the right conditions. Other photosensitive entities that may be used in the present invention include those found in foods, pharmaceuticals, biological materials such as proteins, enzymes, and chemical materials. In the present invention, LPF protection is reported for the light sensitive entity riboflavin. Riboflavin is the preferred entity to track performance for dairy applications although other light sensitive entities may also be protected from the effects of light.

### EXAMPLES

### Treated TiO₂

Treated TiO₂ particles comprising an inorganic surface modification using alumina hydrous oxide, fluoride ions and organosilicon compound were prepared substantially according to the teachings of U.S. Pat. No. 5,562,990.

### Production of Plaque Samples for LPF Value Evaluation

Low density polyethylene (LDPE) (DuPont 20, DuPont, Wilmington, Del.) and TiO₂ and color pigment masterbatch concentrate pellets were pre-weighed in amounts to yield the final ratios desired in batches of 190 g. Concentrate and resin mixtures were compounded on a two-roll mill (Stewart Bolling & Co., Cleveland, Ohio) at 220-240° F. with a gap of 0.035 in. The initial melt was performed with rollers stationary, and roller speed was slowly increased from 10 ft/min to final speeds of 45 and 35 ft/min for front and back rollers, respectively. Material was cut off the rollers, folded, and re-applied a total of 10 times to ensure complete mixing. The material was removed from the rollers for the final time as a single sheet and this stock was immediately cut into smaller pieces to better fit the compression mold. Compression molding of rigid plaques from this material was performed using two hydraulic presses (Carver, Wabash, Ind.) in sequence, the first heated to 350° F. to melt and mold the material and the second water-cooled to freeze the plaque shape. Compounded LDPE material was placed between Mylar sheets over a mold between platens, held for 2 min at a pressure of 25 tons in the hot press, and then for 2 min at 12.5 tons in the cold press. The Mylar was removed and excess plastic around each plaque was trimmed, yielding rectangular plaques about 5 cm by 10 cm with average thickness of approximately 30 mil.

This procedure was repeated at different levels of masterbatch concentrates to produce the desired series of samples with varied composition.

### Top-Load and Crush Resistance Testing

From the Mecmesin (top load tester equipment manufacturer)

http://www.mecmesin.com/top-load-crush-testing

### “Top-Load And Crush Resistance Testing”

Products that are stacked in the course of production, storage, transport or display must be sufficiently robust within desired or industry-standard stacking heights. Top-load or column-crush testing defines methods for ensuring that products consistently meet these quality requirements for axial load.

Plastic bottles and containers, cans, glass jars, or cardboard cartons, will all behave differently according to contents, materials and structural design. Cost and environmental pressures for lighter packaging using less raw materials, also affect performance during filling and capping, as containers become more susceptible to crushing, or deforming in ways that must be designed out.

A common example of a stacked container is the PET bottle, used globally for beverages, cooking, cleaning and other liquids. It has design features that affect axial load strength, including closure, handles, grip areas, and shoulder and base design. Some designs are made for unit-to-unit stacking to further minimize batch packaging and increase stack stability. Top-load testing is therefore as integral a part of the design process, as it is of production line quality testing.

A top-load test essentially involves applying a downwards compression to measure resistance to crushing of a product, usually a container. Test methods define the speed of compression and extent of deformation, and peak force measurement determines the product sample strength. An appropriate universal tester will also be able to measure accurately the initial and recovered height of the sample, for conformance to specification.

In the case of multi-wall cardboard materials, standardized samples of the material itself are assessed for rigidity by edge crush testing, since this is predictive of final construction strength. Contents, head space and weight, as well as humidity and storage conditions greatly affect the load-bearing of a cardboard container. The strength and suitability of a complete cardboard box may therefore also involve compressive burst testing under various conditions.

### Crush Test Fixtures

Compression fixtures account for the behavior of the sample, so a plate for crush testing a bottle may be vented, or have a cone center that prevents a bottle slipping sideways. A plate for crushing a box may be self-levelling to follow the pattern of failure. Edge crush methods may require special fixtures, for example to retain a circular ring of cardboard. If a filled container such as a beverage can is to be tested, a suitable enclosure and containment is required. If glass top-load is to be done, additional safety enclosures are essential.”

### Example 1

Material samples were produced representing a range of plastic package material compositions using the described plastic plaque production method. The treated TiO₂ (Ti-Pure TS-1600, from The Chemours Company) and black pigments (FDA channel black, from Ampacet) were incorporated within these samples in defined and varying amounts to achieve a range of compositions seen in the table below.

The light protection performance of a material can be quantified with an LPF value. This series of colored plaque plastic samples were evaluated for their LPF value.

| | Treated TiO2 | Black Pigment | LPF |
|---|---|---|---|
| Sample | wt %) | (wt %) | value |
| 1-A | 1.1 | 0.0E+00 | 13.3 |
| 1-B | 1.1 | 4.0E−04 | 14.3 |
| 1-C | 4.3 | 0.0E+00 | 59.0 |
| 1-D | 4.3 | 4.0E−04 | 70.1 |

The treated TiO₂ material used alone at 1.1 wt % in sample 1-A provided a modest LPF value of 13.3 providing light protection benefits over a natural resin material which would test at LPF value less than 1. By adding a small amount of black pigment material at 4.0E-04 wt % in sample 1-B, the LPF value is only increased a slight amount by 1 LPF unit to 14.3, an increase of 7.5% in light protection performance.

When treated TiO₂ was used at 4.3 wt % in sample 1-C the LPF value was 59. When black pigment was added at 4.0E-4 wt % in addition to the 4.3 wt % TiO₂ in sample 1-D, an increase of over 10 units was seen in the LPF value to reach an LPF value of 70.1 representing an increasing of almost 19% in light protection performance.

Thus, by increasing the treated TiO₂ material in conjunction with the level of black material an unanticipated synergistic effect is found in the light protection performance of the resultant material.

This enhanced light protection performance provides a benefit as it can be achieved at levels of treated TiO₂ and black pigment materials that will not have a substantial degradation of other material properties such as the mechanical properties of the resultant packages which can be a concern for package design.

### Example 2

Plaques were produced using the methods and materials described above in Example 1 to result in plaques with the levels of pigments noted below. The resultant plaques were evaluated for LPF value using the above-mentioned methods.

| | Treated TiO2 | Black Pigment | LPF |
|---|---|---|---|
| Sample | (wt %) | (wt %) | value |
| 2-A | 0 | 2.0E−04 | 0.2 |
| 2-B | 0 | 4.0E−04 | 0.2 |
| 2-C | 0 | 1.0E−03 | 0.2 |
| 2-D | 0 | 2.0E−03 | 0.2 |
| 2-E | 0.5 | 2.0E−03 | 9.6 |
| 2-F | 2.1 | 0 | 29.3 |
| 2-G | 2.1 | 2.0E−03 | 69.3 |

With no treated TiO₂ present, increasing the level of black masterbatch at low levels resulted in little to no change in the LPF value of the resultant plaque indicating essentially no light protection performance benefits of this material when used alone. This is seen in samples 2-A, 2-B, 2-C, and 2-D which all have essentially the same low level of light protection performance below LPF value of 1.

Surprisingly, with minor addition of the treated TiO₂ with the black pigment that there is a disproportionate increase in the LPF value. For the black level of 2.0E-03 wt % in samples 2-D, 2-E, and 2-G the addition of 2.1 wt % treated TiO₂ in sample leads to a greater than two orders of magnitude increase in the LPF value over 300× that of the plaques with only the black colorant. The LPF value boost for the addition of 2.1 wt % treated TiO₂ alone without black (sample 2-F) was about half of that seen with the black. This illustrates the synergistic effect of light protection performance of TiO₂ with black pigment.

### Example 3

Bottle 3N was produced using extrusion blow molding. Three additional bottle designs (3A, 3B, 3C) are proposed and could be similarly produced by extrusion blow molding. All bottle designs produced and proposed have a side wall thickness of 19 mil. The compositions of these bottles designs would be varied by adjusting the ratio of masterbatches added to the process to achieve the resultant proposed compositions in an HDPE matrix. Bottle design 3C incorporates a masterbatch with black pigment (FDA black) to provide the light protection benefits disclosed herein.

For bottle 3N, LPF value was measured and a Mecmesin top-load tester (MultiTest 10-i) was used to assess for the top load performance using standard industry procedures with 5″ per minute feed rate with the Top Load value reported at 0.250″ deflection. We predict data for the bottle designs in 3A, 3B, and 3C based on models developed through experimentation that relate the composition of materials to their properties including LPF and Top Load.

| | Treated | Black | | Top | Top Load |
|---|---|---|---|---|---|
| | TiO2 | Pigment | LPF | Load | (relative |
| Sample | (wt %) | (wt %) | value | (Ibf) | to 3N) |
| 3-N | 0.0% | 0.0000% | 0.8 | 37.1 | 0% |
| 3-A | 2.0% | 0.0000% | 16.8 | 34.0 | −8% |
| 3-B | 3.0% | 0.0000% | 25.1 | 33.1 | −11% |
| 3-C | 2.0% | 0.0009% | 25.0 | 34.0 | −8% |

The light protection performance as indicated by the LPF value was measured for bottle 3N and it is poor with an LPF value measuring below 1. We anticipate the LPF value of bottles 3A, 3B, and 3C using models based on extensive experimentation. Incorporation of the light protection TiO₂ material leads to improved LPF value. To achieve even higher LPF value, additional light protection performance can be obtained by increasing the TiO₂ level. While this increased TiO₂ loading enhances the LPF value it also leads to decline in the mechanical properties of the resultant package as indicated by the top load value.

Top load was measured on bottle 3N. The decline in top load for bottles 3A, 3B, and 3C would be measured and these results could be comparted to bottle 3N. These results are anticipated based upon experimental models.

For this design the objective was to achieve an LPF value of 25 or greater with a top load decline relative to natural resin of less than 10%. The bottle 3A design allowed for improvement in light protection performance with only modest decline in the top load strength as compared to Bottle N. However, the LPF value of 16.8 did not meet the target of an LPF value of 25. Increasing light protection TiO₂ in bottle 3B allowed the target of an LPF value of 25 to be achieved but the top load decline was unacceptable at 11% decline.

In order to meet the light protection performance of bottle 3B but with acceptable mechanical performance as seen in bottle 3A, bottle 3C design of the invention of this application is proposed at the same TiO₂ content of bottle 3A but with the addition of the black masterbatch material to enhance the light protection performance. With bottle 3C design, we anticipate the LPF value will exceed 25 while maintaining acceptable mechanical performance desired with a top load decline of 8% demonstrating the utility of the invention.

### Example 4

Bottle 3N was produced using extrusion blow molding. Two additional bottle designs (4D, 4E) are proposed and could be similarly produced by extrusion blow molding. All bottle designs produced and proposed have a side wall thickness of 19 mil. The compositions of these bottles designs would be varied by adjusting the ratio of masterbatches added to the process to achieve the resultant proposed compositions in an HDPE matrix. Bottle design 4E incorporates a masterbatch with black pigment (FDA black) to provide the light protection benefits disclosed in this invention.

As in Example 3, we predict data for the bottle designs in 4D and 4E based on our models developed through experimentation that relate the composition of materials to their properties including LPF value and Top Load.

| | Treated | Black | | Top | Top Load |
|---|---|---|---|---|---|
| | TiO2 | Pigment | LPF | Load | (relative |
| Sample | (wt %) | (wt %) | value | (Ibf) | to 3N) |
| 3-N | 0.0% | 0.0000% | 0.8 | 37.1 | 0% |
| 4-D | 8.0% | 0.0000% | 66.3 | 28.6 | −23% |
| 4-E | 2.8% | 0.0030% | 65.4 | 33.3 | −10% |

For this design the objective was to achieve an LPF value of 65 or greater with a top load decline relative to natural resin of less than 15%. While bottle design 4D was able to achieve the desired LPF value, the top load decline of 23% was too high. By using the design of this invention that incorporates a masterbatch with black pigment (FDA black) to provide the light protection benefits in bottle 4E, the LPF value was achieved while maintaining a top load decline of only 10%. Thus, bottle design 4E can simultaneously meet the LPF™ value and top load performance requirements for the desired bottle use.

### Example 5

Material samples were produced representing different plastic package material compositions using the described plastic plaque production method using treated TiO₂ (Ti-Pure™ R101, from the Chemours Company) and yellow pigment (PY191) color concentrates which were incorporated within these samples in defined and varying amounts to achieve a range of compositions seen in the table below.

| | Treated TiO2 | Yellow Pigment | LPF |
|---|---|---|---|
| Sample | (wt %) | (wt %) | value |
| 5-A | 0 | 0.02 | 0.7 |
| 5-B | 0.5 | 0 | 3.7 |
| 5-C | 0.5 | 0.02 | 22.7 |

The use of yellow pigment alone (5-A) resulted in a low LPF value of the resultant material below an LPF value of 1, indicating no light protection performance benefits of this composition. TiO₂ used alone (5-B) shows some light protection performance benefits with an LPF of 3.7. We see the unanticipated synergistic effect of TiO₂ and yellow pigment together (5-C) with a disproportionate increase in the LPF value where there is a 6× enhancement over the TiO₂ only sample and a 32× enhancement over the yellow pigment only sample. The LPF value of 5-C meets the light protection requirements for the bottle design.

### Example 6

Material samples were produced representing different plastic package material compositions using the described plastic plaque production method using treated TiO₂ (Ti-Pure™ R101, from the Chemours Company) and yellow pigment (PY191) or TiO₂ (Ti-Pure™ TS-1600, from the Chemours Company) and green pigment (PG7) color concentrates which were incorporated within these samples in defined and varying amounts to achieve a range of compositions seen in the table below.

| | Color | LPF | Treated TiO2 | Color Pigment |
|---|---|---|---|---|
| Sample | Pigment | value | (wt %) | (wt %) |
| 6-A | PY191 | 85.1 | 0.5 | 0.05 |
| 6-B | PY191 | 39.1 | 0.3 | 0.05 |
| 6-C | PY191 | 1.6 | 0.0 | 0.05 |
| 6-D | PG7 | 24.8 | 0.5 | 0.05 |
| 6-E | PG7 | 12.9 | 0.3 | 0.05 |
| 6-F | PG7 | 1.1 | 0.0 | 0.05 |

The use of yellow or green pigment alone in samples 6-C and 6-F, respectively, resulted in a low LPF value of the resultant material, of ˜LPF 1, indicating no light protection performance benefits of this composition. Using the same level of color pigment of 0.05 wt %, treated TiO₂ was then used at two levels (0.3 and 0.5 wt %) in combination with the color pigments.

We see the unanticipated synergistic effect of treated TiO₂ and yellow pigment together in samples 6-A and 6-B with their strong increase in LPF™ value. Sample 6-A with yellow pigment and treated TiO₂ shows over 50× increase in LPF as compared to 6-C containing only yellow pigment.

The use of green pigment with treated TiO₂ (6-D, 6-E) shows LPF™ value enhancement, but the levels of enhancement are less than the performance of the yellow pigment indicating preferred benefits of yellow pigment for LPF value. The yellow pigment samples performed over 3× better versus the green pigment samples comparing 6-A versus 6-D.

What is claimed is:

1. A rigid, monolayer package comprising:
a) titanium dioxide particles;
b) at least one color pigment selected from the group consisting of black and yellow; and
c) a polymer material, wherein the titanium dioxide particles and the at least one color pigment are dispersed in the polymer material and the package has an LPF value of at least about 20.

2. The package of claim 1, wherein the titanium dioxide particles comprise at least about 1 wt % of the total weight of the package.

3. The package of claim 2, wherein the at least one color pigment comprise about 0.01 wt % or less of the total weight of the package.

4. The package of claim 3, wherein the titanium dioxide particles comprise from about 0.01 wt % to about 8 wt % of the total weight of the package.

5. The package of claim 4, wherein the package has a light protection value of at least about 30.

6. The package of claim 5, wherein the package has a light protection value of at least about 40.

7. The package of claim 6, wherein the package has a light protection value of at least about 50.

8. The package of claim 1, wherein the TiO₂ is coated with a metal oxide and an organic material.

9. The package of claim 8, wherein the metal oxide is selected from the group consisting of silica, alumina, zirconia, or combinations thereof.

10. The package of claim 9, wherein the metal oxide is alumina.

11. The package of claim 8, wherein the organic material is selected from the group consisting of an organo-silane, an organo-siloxane, a fluoro-silane, an organo-phosphonate, an organo-acid phosphate, an organo-pyrophosphate, an organo-polyphosphate, an organo-metaphosphate, an organo-phosphinate, an organo-sulfonic compound, a hydrocarbon-based carboxylic acid, an associated ester of a hydrocarbon-based carboxylic acid, a derivative of a hydrocarbon-based carboxylic acid, a hydrocarbon-based amide, a low molecular weight hydrocarbon wax, a low molecular weight polyolefin, a co-polymer of a low molecular weight polyolefin, a hydrocarbon-based polyol, a derivative of a hydrocarbon-based polyol, an alkanolamine, a derivative of an alkanolamine, an organic dispersing agent, or mixtures thereof.

12. The package of claim 1, wherein the polymer comprises a melt-processable polymer.

13. The package of claim 12, wherein the melt-processable polymer comprises a high molecular weight polymer.

14. The package of claim 1, wherein the polymer comprises a material selected from the group consisting of polyethylene, polypropylene, polybutylene, copolymers of ethylene, polyvinyl chloride, polyvinyl acetate, polystyrene, acrylic homopolymers and copolymers, phenolics, alkyds, amino resins, polyamides, phenoxy resins, polysulfones, polycarbonates, polyesters and chlorinated polyesters, polyethers, acetal resins, polyimides, polyoxyethylenes, and mixtures thereof.

15. The package of claim 1, wherein the polymer comprises a material selected from the group consisting of low density polyethylene, linear low density polyethylene, polypropylene, high density polyethylene, and mixtures thereof.

16. The package of claim 1, wherein the monolayer has a thickness of from about 5 mils to about 100 mils.

17. The package of claim 16, wherein the monolayer has a thickness of from about 10 mils to about 40 mils.

18. The package of claim 17, wherein the monolayer has a thickness of from about 35 mils to about 40 mils.
